(19) United States
(12) Patent Application Publication
(10) Pub. No.: US 2002/0138512 A1
(43) Pub. Date: Sep. 26, 2002

(54) Flexible form and window arrangement for the display of medical data

(76) Inventors: William Buresh, Salem, MA (US); Geoffrey Waite, Topsfield, MA (US)

Correspondence Address: Siemens Corporation, Intellectual Property Department, 186 Wood Avenue South, Iselin, NJ, 08830, US

(21) Appl. No.: 10/004,239

(22) Filed: Nov. 15, 2001

Related U.S. Application Data
(60) Provisional application No. 60/249,571, filed on Nov. 17, 2000.
(60) Provisional application No. 60/249,829, filed on Nov. 17, 2000.

(51) Int. Cl. G06F 17/24

(52) U.S. Cl. 707/507

(57) ABSTRACT

A medical image and data system including a configurable tabular form editor (19) which creates a table (35) divided into multiple cells (34, 35, 36, 37). A data selection menu (29) appears when a cell (34) is highlighted with a mouse type pointing device. Real time data may be inserted into a selected cell and the cell (46) may be manually resized by the user, causing adjacent cells (45) to be automatically redimensioned to accommodate the manually resized cell (46) as data within the other cells (45). A large multiple cell table (44) may be created by using a flexible form menu (10). Data may be inserted into a multiple cell table (65) which may itself be inserted into a cell of another table (67). All cell and data selections may be performed with the mouse pointing device.

### CROSS REFERENCE TO RELATED APPLICATIONS

This application is a nonprovisional application based on Provisional Applications Ser. Nos. 60/249,571 and 60/249,829.

### FIELD OF THE INVENTION

The present invention relates to a user configurable screen presentation system for the simultaneous presentation of various types of medical data.

### BACKGROUND OF THE INVENTION

Health care facilities typically possess significant amounts of patient information, including both clinical and patient management data. Patent information can include many parameters relating to the patient's condition, laboratory test results, professional and automated assessments, and the administration of treatments. The ready availability of computers has resulted in advances in computer imaging and data processing which have made possible the delivery of many video based medical images such as ultrasounds, X-rays and real time patient vital signs.

The Microsoft Corporation of Redmond, Washington has developed various Microsoft-Windows software packages which provide the software to create and manipulate an area on a computer screen called a “window”, an area in which an image or other data can be displayed. Windows are rectangular areas defined and presented on a single screen which may partially or completely fill the available screen area, and in some instances may overlap each other thereby obscuring some of the information within a particular window. A window can even be greater in size than the available screen area and thus require movement of the window to view its entire content.

Windows based software is the widely accepted standard for viewing information at a single screen workstation or device. In the context of image and data viewing, the user may desire to see several related sets of information at once. Any attempt to create a rigid patient information database is hampered by the large amount of data available and the need of any particular health care professional to view only portions of that data. In an effort to minimize screen clutter, desired parameters may not be available at all. Various techniques for dealing with the data presentation problem have been disclosed.

For example, U.S. Pat. No. 5,682,526 entitled METHOD AND SYSTEM FOR FLEXIBLY ORGANIZING, RECORDING AND DISPLAYING MEDICAL PATIENT CARE INFORMATION USING FIELDS IN A FLOW SHEET, issued Oct. 28, 1997 to Smokoff et al. discloses one such technique. The system disclosed in this patent includes a central patient data storage facility in which patient information is stored and in which various data user profiles are also configured. The user profiles permit a particular health care professional to view particular parameters and to define flowsheets which show data gathered at particular times and having some relationship to other data that is gathered. For example, a table may be created which shows the observed condition of a patient's cough at given time intervals as well as the times at which a drug such as Demerol was administered, the dosage given and other treatment information such as observed chest sounds. The information provided is presented on a screen as text only, and additional text related to current observations may be entered via a keyboard at the workstation.

A system of displaying sets of images is disclosed in U.S. Pat. No. 5,805,118 entitled DISPLAY PROTOCOL SPECIFICATION WITH SESSION CONFIGURATION AND MULTIPLE MONITORS issued to Mishra et al. This patent discloses a system for viewing multiple images as may be required, for example in the field of radiology. A finite set of workstation viewing modes is defined, which would include the number of monitors used, the number of images to be displayed and which images are to be shown simultaneously. Specific “session types” are predefined which correspond to specific user needs such as spinal examinations or abdominal examinations.

A “user to session database” is employed to determine if the user has predefined a specific configuration file for the session name they are trying to access. The user is offered a palette of available image sessions. The layout constraints are based on the user choosing the particular number of images she wishes to observe and the number and size of monitors available. The Mishra et al. software computes if or how best this may be accomplished. In some cases the images will necessarily be viewed sequentially rather than simultaneously, or a single image may extend over multiple monitors.

Another system used for simultaneously viewing large amounts of data is disclosed in U.S. Pat. No. 5,966,139 entitled SCALABLE DATA SEGMENTATION AND VISUALIZATION SYSTEM issued to Anupam et al. In the Anupam system a single screen is divided into a large number of identical rectangles or nodes which each contain discrete graphical data. The data is not presented in real time, but the scaling between related graphs can be scaled in near real time so that comparisons between adjacent nodes has some meaning. The purpose of this system is to permit simultaneous inspection of related data making it possible for a skilled observer to detect trends, peaks and periods of relative stability or inactivity. An individual node can be selected and enlarged within limits so that its data may be more easily viewed.

A final example of a medical image display scheme is disclosed in U.S. Pat. No. 5,987,345, entitled METHOD AND SYSTEM FOR DISPLAYING MEDICAL IMAGES, issued to Engelmann et al. When multiple anatomical images are taken over a period of time the sequential photographs may be compared by overlaying and digitally combining or subtracting the images, thus highlighting the changes between the photographs. In this manner the spread or retreat of some abnormal condition may be more readily identified. The areas of the screen are fixed in their size and arrangement, and the data is not presented in real time. The data is limited to specific photograph data and does not include text or instrumentation information as an integrated part of the display.

### BRIEF SUMMARY OF THE INVENTION

In accordance with the principles of the present invention, a graphical user interface includes the ability to present on a single computer screen a user selectable number of individual tiles or cells. Within each cell the user may select the information to be displayed. In a medical context, that information can include alarm monitors, real time physiological parameters, photographic images, video data or a web browser. The information displayed within each cell is typically chosen from a selection of menus by a mouse type pointing device.

After the window cell or “form” layout is initially chosen, the individual cells may be enlarged or reduced and their aspect ratio altered. The background color of each cell may be selected. If graphical data such as a patient's heart rate is selected for display in a particular cell, additional graphical data, such as the patient's respiration rate, may be chosen for display in the same cell, thereby causing the two graphs to be superimposed along a common time axis. A window cell layout may be devoted exclusively to real time text data, such as numerical readouts of heart rate and blood pressure, for example, along with other parameters. Such a window cell arrangement or form may then be inserted in its entirety into a single cell of a second form.

Particular window cell or form configurations and their user selected contents can be saved under the name of a given health care professional, patient or treatment protocol. Thus, once a particular presentation of information is found to be optimum for a given person or situation it may be quickly recalled without the need for any customized setup. Once recalled, the display may still be modified and may either be saved or discarded after the alteration of the cells.

A standard Microsoft Windows environment is used in implementing the cell layouts, menu selections and the manipulations of the mouse pointing device, thereby simplifying the use of the present invention for anyone already familiar with the operation of a personal computer.

### BRIEF DESCRIPTION OF THE DRAWING

In the drawing:

FIG. 1 is a pictorial representation of the graphical user interface flexible form selection window;

FIG. 2 is a pictorial representation of a table of cells produced by a selection from the selection window depicted in FIG. 1;

FIG. 3 is a pictorial representation of a table of cells containing widgets in some of the cells with one cell selected for redimensioning;

FIG. 4 is a pictorial representation of the table depicted in FIG. 4 after one cell has been redimensioned;

FIG. 5 is a pictorial representation of a table of cells in which all of the cells in one column have been selected for redimensioning;

FIG. 6 is a pictorial representation of the table of cells depicted in FIG. 5 after all of the cells in the selected column have been redimensioned;

FIG. 7 is a pictorial representation of a table of cells in which a cell has been selected for modification;

FIG. 8 is a pictorial representation of the table of cells depicted in FIG. 7 in which an additional waveform has been superimposed on the cell selected for modification;

FIG. 9 is a pictorial representation of the graphical user interface menus used to select the content of an individual cell;

FIG. 10 is a pictorial representation of the table depicted in FIG. 3 after the widget in the selected cell has been replaced;

FIG. 11 is a pictorial representation of the table depicted in FIG. 3 after the two of the cells have been highlighted;

FIG. 12 is a pictorial representation of a table of cells optimized for a first user showing one cell selected for modification;

FIG. 13 is a pictorial representation of the table of cells depicted in FIG.13 after being optimized for a second user;

FIG. 14 is a pictorial representation of a first form configured as table of textual values;

FIG. 15 is a pictorial representation of a second form configured as a table of textual values;

FIG. 16 is a pictorial representation of a third form in which the forms depicted in FIGS. 14 and 15 have been inserted;

FIG. 17 is a pictorial representation of a display editor graphical user interface for choosing certain common cell layouts and cell contents showing a four cell configuration;

FIG. 18 is a pictorial representation of a the display editor graphical user interface depicted in FIG. 17 showing a single cell configuration; and

FIG. 19 is a pictorial representation of a graphical user interface that permits a particular form layout to be saved for future use.

### DETAILED DESCRIPTION OF THE INVENTION

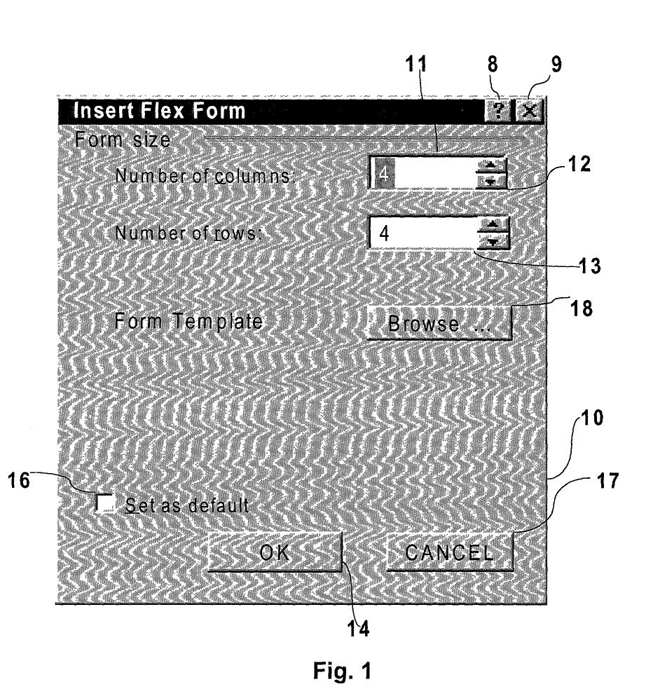

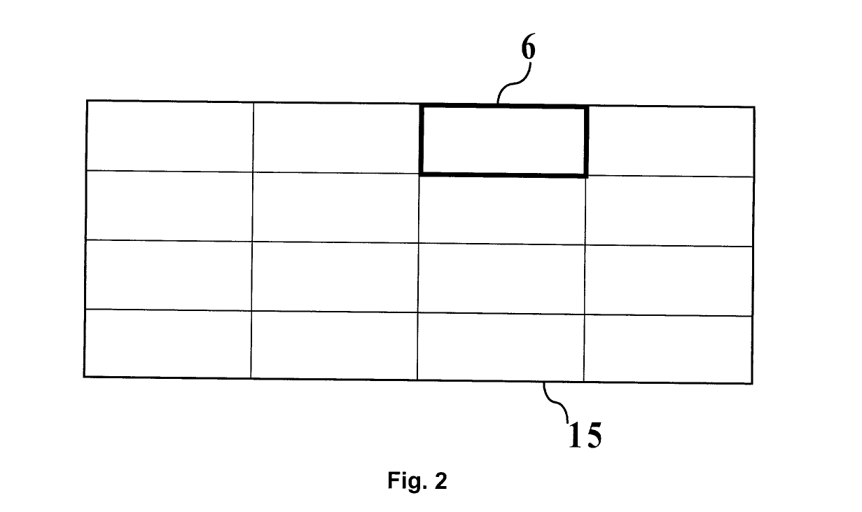

FIG. 1 is a pictorial representation of a graphic user interface 10 which permits the user to select a basic tabular format. The column selector box 11 permits the user to either directly enter the number of columns desired via a keyboard or by using a mouse type pointing device in conjunction with the selection arrows 12. Similarly, the number of rows may be selected within the row selector box 13. In the example shown, selecting the OK box 14 results in a four row by four column table 15 as seen in FIG. 2. This particular configuration could be selected as the preferred table by selecting the SET AS DEFAULT box 16. The interface 10 can be removed from the screen either by selecting the CANCEL box 17 or clicking the “X” box 9. A HELP menu is available by selecting the “?” box 8.

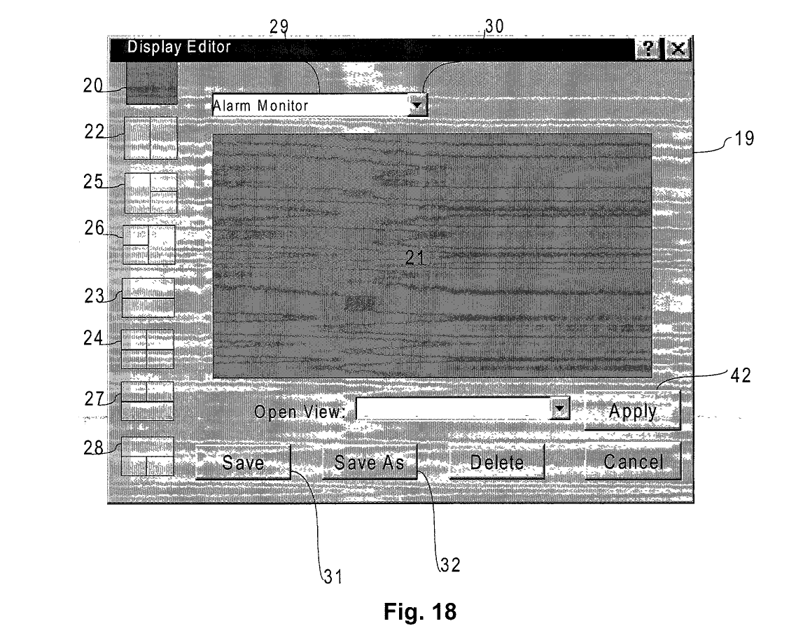

The BROWSE selection box 18 permits the user to choose other tabular formats that vary from a larger multicolumn and multirow protocol. An example of a type of alternate table that could be available for selection is depicted in FIG. 18 as DISPLAY EDITOR interface 19. In the particular example shown, the highlighted table selection 20 produces a single rectangle 21.

Other table formats are possible on this particular interface 19, including a two column, single row table 22, a two row, single column table 23 and a two row, two column table 24. More elaborate asymmetrical tables may also be chosen via interface 19 including table 25 in which a first column has one row and a second column has two rows. Table 26 is the mirror image of table 25. Table 27 includes a first row having two columns and a second row having only one column. Table selection 28 is the inverted image of table 27.

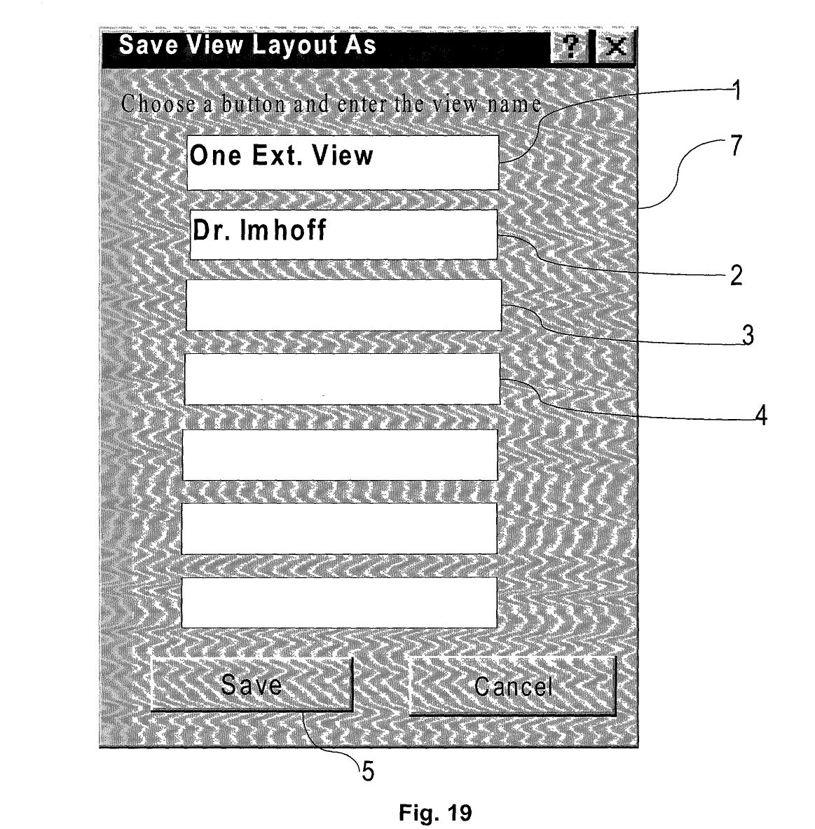

For the single rectangle 21 displayed, a menu 29 appears either adjacent to or within the rectangle 21. While a single selection ALARM MONITOR is shown, selecting the menu arrow 30 will produce additional selections such as, for example, HEART RATE, RESPIRATION, BLOOD PRESSURE, etc. Some of the additional selections may produce additional submenus to provide a greater variety of choices. Once the menu selection has been made the tabular configuration may be saved under the existing file name by choosing the SAVE box 31, or under a different file name by choosing the SAVE AS dialog box 32. As seen in FIG. 19, selecting dialog box 32 causes menu 7 to be displayed. Menu 7 includes a number of file button bars 1, 2, 3, 4, etc. To save a table configuration under a new file name, a box is selected and the file name is entered via a keyboard. Selecting the SAVE dialog box 5 will save the file name and the associated tabular view.

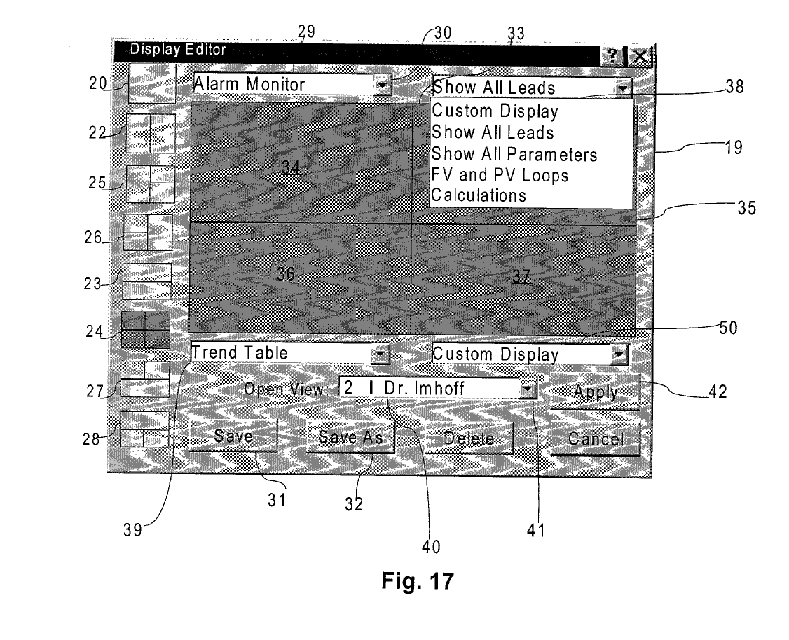

The effect of choosing table format 24 is depicted in FIG. 17. A two column, two row table 33 is produced having four individual cells 34, 35, 36 and 37. Each cell has an associated menu box. For example, menu 29 now corresponds to adjacent rectangle 34. A new menu 38 is associated with rectangle 35, and includes the choices CUSTOM DISPLAY, SHOW ALL LEADS, SHOW ALL PARAMETERS, FV and PV LOOPS, and CALCULATIONS. These selections are not exhaustive but instead are only examples of the type of data that could be displayed in rectangle 35. For example, menu 39 which is associated with rectangle 36 includes the additional menu choice TREND TABLE. It is further possible for the output display generated by programs commonly available with the Microsoft Windows operating system, such as a word processor or internet browser, to be selected for display in a specified rectangle.

A user of the DISPLAY EDITOR 19 who has previously chosen a selected table format and saved it for future use may quickly recall that format via the OPEN VIEW dialog box 40. Selecting the arrow 41 will produce a menu of file names similar to that depicted in FIG. 19. Once the desired file name is highlighted, selecting the APPLY button 42 will cause the chosen file configuration to be displayed.

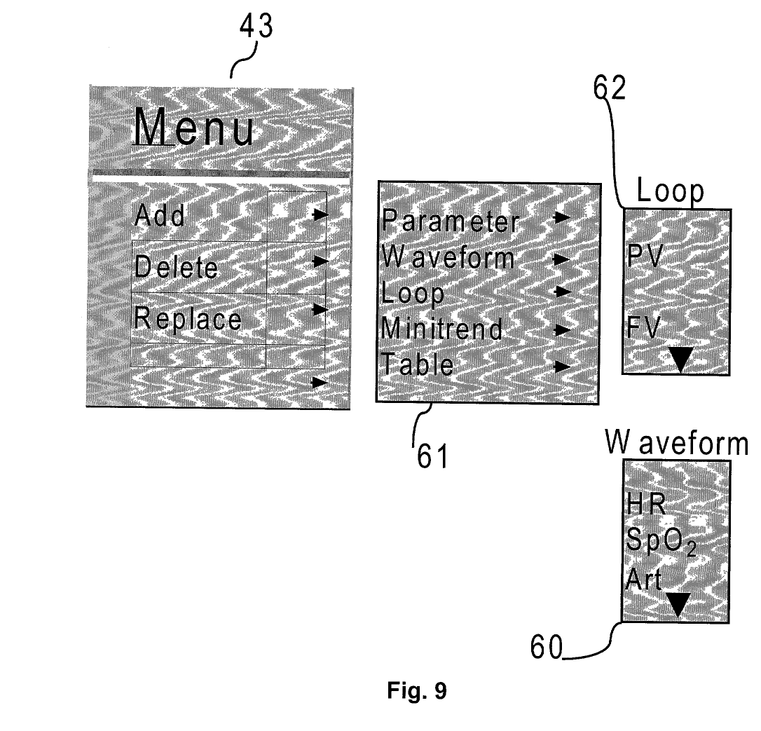

When the CUSTOM DISPLAY selection 50 is chosen, regardless of the overall table format chosen, a number of additional manipulations of the cell or rectangle 37 are possible. Display images from imaging, hospital information systems, charting systems, ECG analysis and third party applications (such as a word processing or web browsing program) may be inserted into the rectangle. The specific manipulation of a cell or rectangle may be seen in FIG. 2, where, by moving a mouse pointing device over a chosen cell 6 the cell may be highlighted. An associated menu 43 as seen in FIG. 9 appears, which permits the insertion of the desired data.

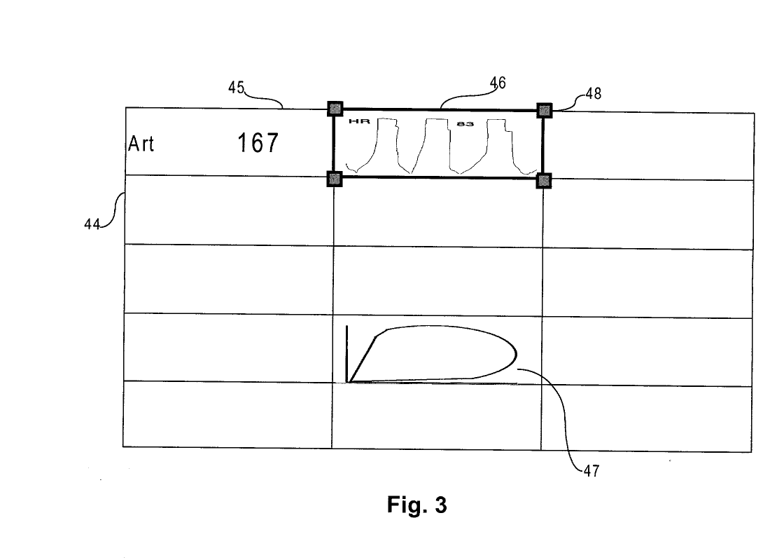

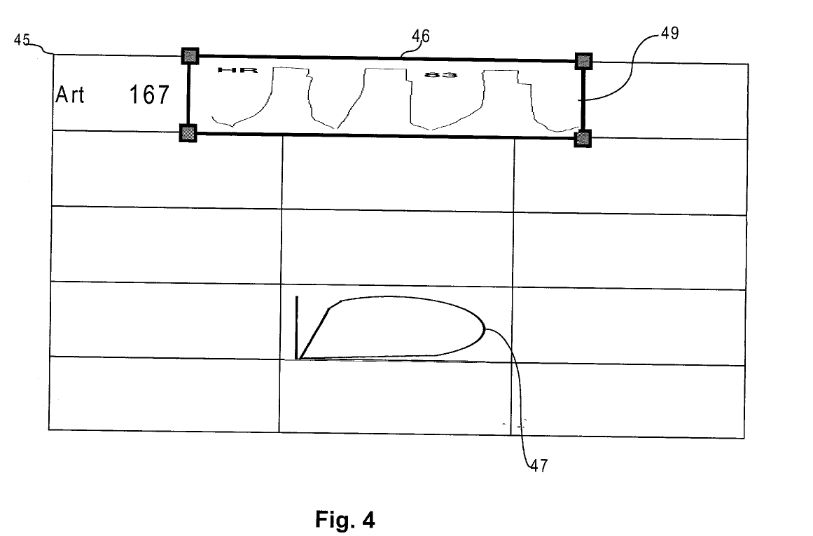

Once data is inserted in one or more cells, further manipulations are possible. As seen in FIG. 3, data has been placed in three different cells of table 44. The first cell 45 contains real time rate data from a selected sensor, a second cell 46 contains a real time heart rate waveform, and a third cell 47 contains a PV loop diagram. If the user of the table 44 wishes to enlarge the waveform data in cell 46, this may be accomplished by first highlighting the cell as shown by the darkened and enlarged corners 48. As seen in FIG. 4, the cell 46 may be enlarged as shown simply by dragging the vertical lines 49 horizontally with a mouse type pointing device. The data in cell 45 is automatically compressed to compensate for the reduced width of cell 45.

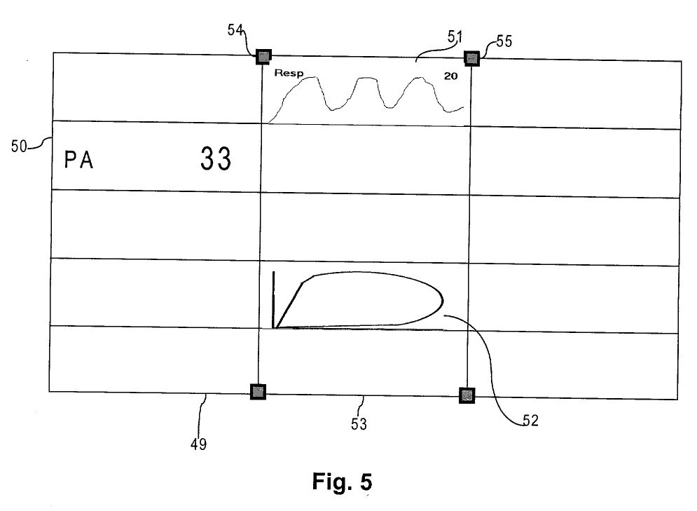

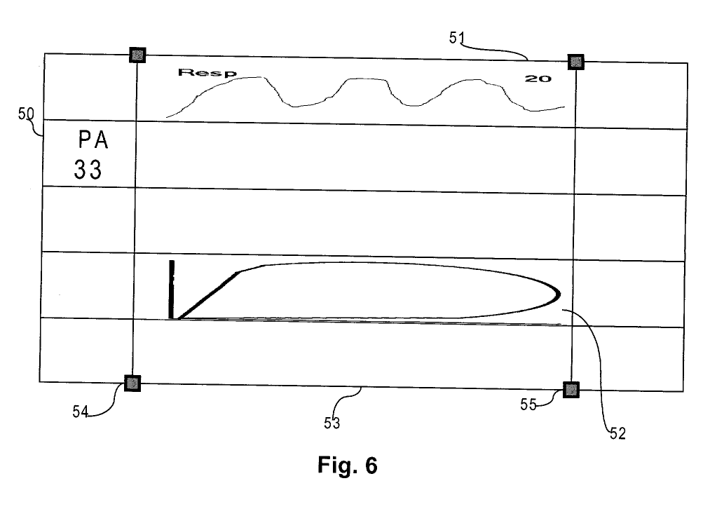

FIGS. 5 and 6 illustrate how an entire column of cells may be simultaneously enlarged. The table 49 contains three data containing cells 50, 51 and 52, the latter two residing in the same column 53. The column 53 is highlighted by a mouse device and the vertical lines 54 and 55 are dragged horizontally to produce the wider column 53 shown in FIG. 6. The data in cell 50 has been automatically compressed to compensate for the increased width of column 53.

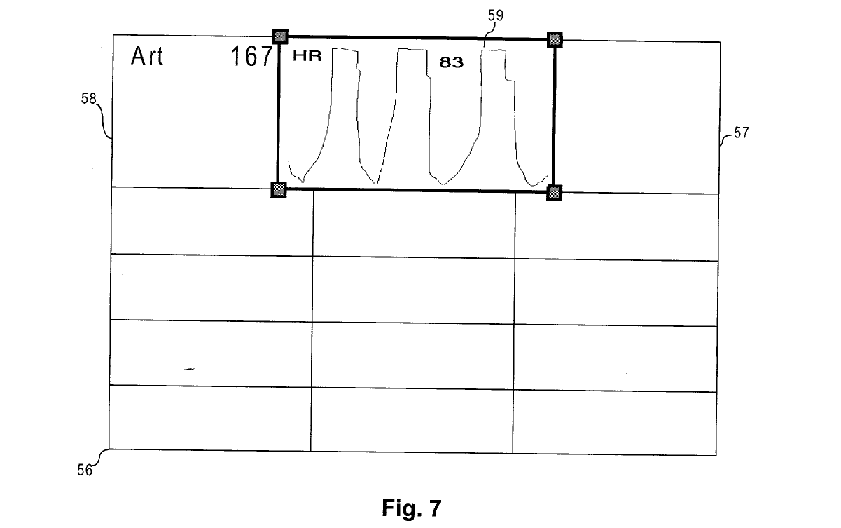

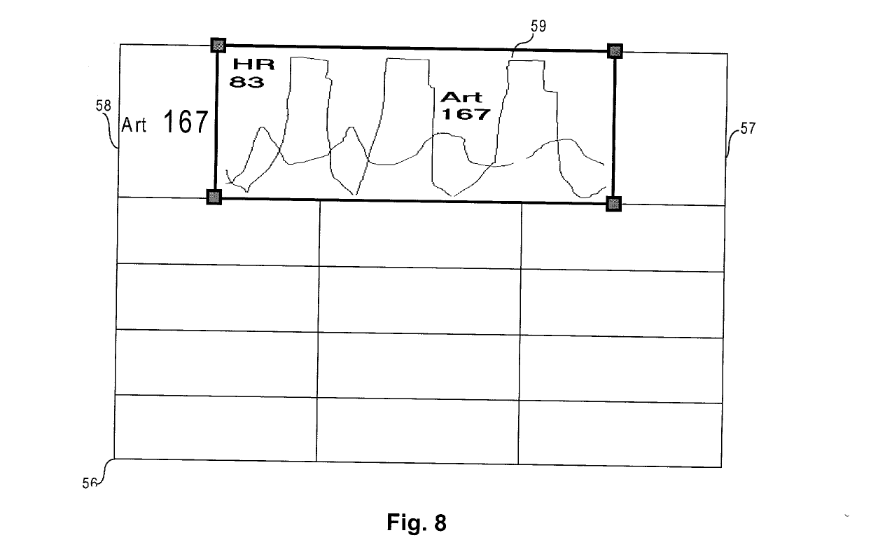

Referring also to FIG. 7, table 56 is shown having an enlarged first row 57 which contains real time data in cells 58 and 59. Cell 59 contains a HEARTRATE waveform. The user may add a second waveform to the cell 59 by choosing the ADD command from Menu 43, subsequently choosing the WAVEFORM selection from menu 61 and then choosing the desired waveform, such as HEARTRATE, Sp02, ART, etc. from the next menu 60 which appears after WAVEFORM is selected. FIG. 8 depicts the two superimposed HR and ART waveforms residing in the same cell 59.

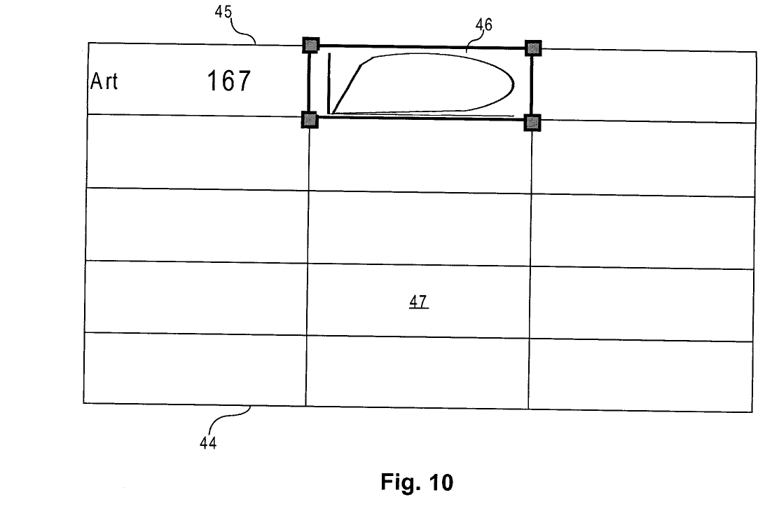

The REPLACE and DELETE functions can be understood by comparing FIGS. 3 and 10. The user of the display shown in FIG. 3 desires to delete the data in cell 47 and replace the data in cell 46 with the data previously in cell 47. Cell 47 is first highlighted causing menu 43 to appear. The DELETE command is chosen and the PV LOOP data is removed. Cell 46 is next highlighted and the REPLACE command is chosen from menu 43. Menu 61 then appears and LOOP is selected, causing the LOOP menu 62 to appear from which PV is selected. The result of these manipulations is shown in FIG. 10.

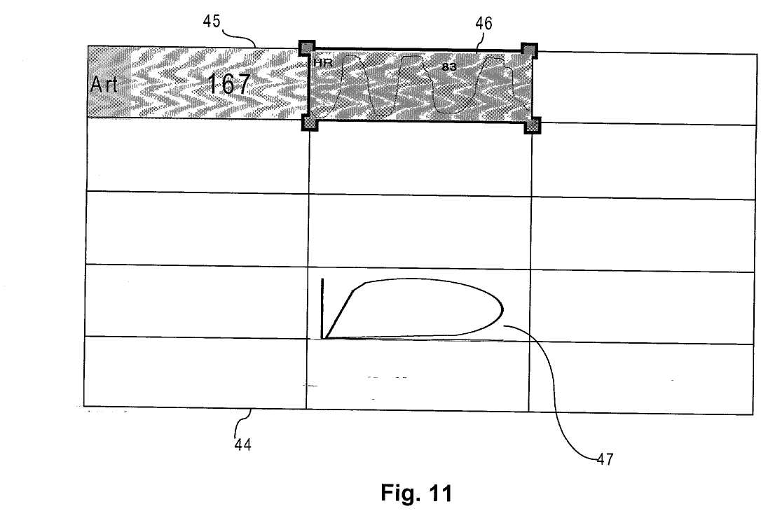

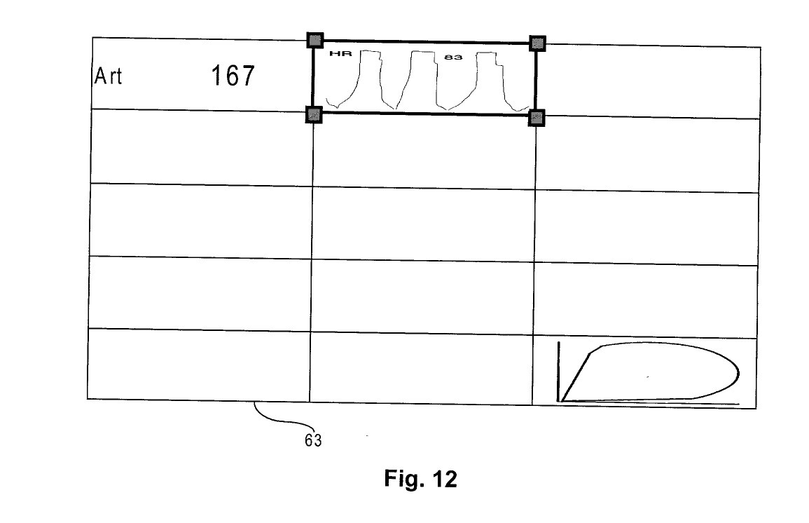

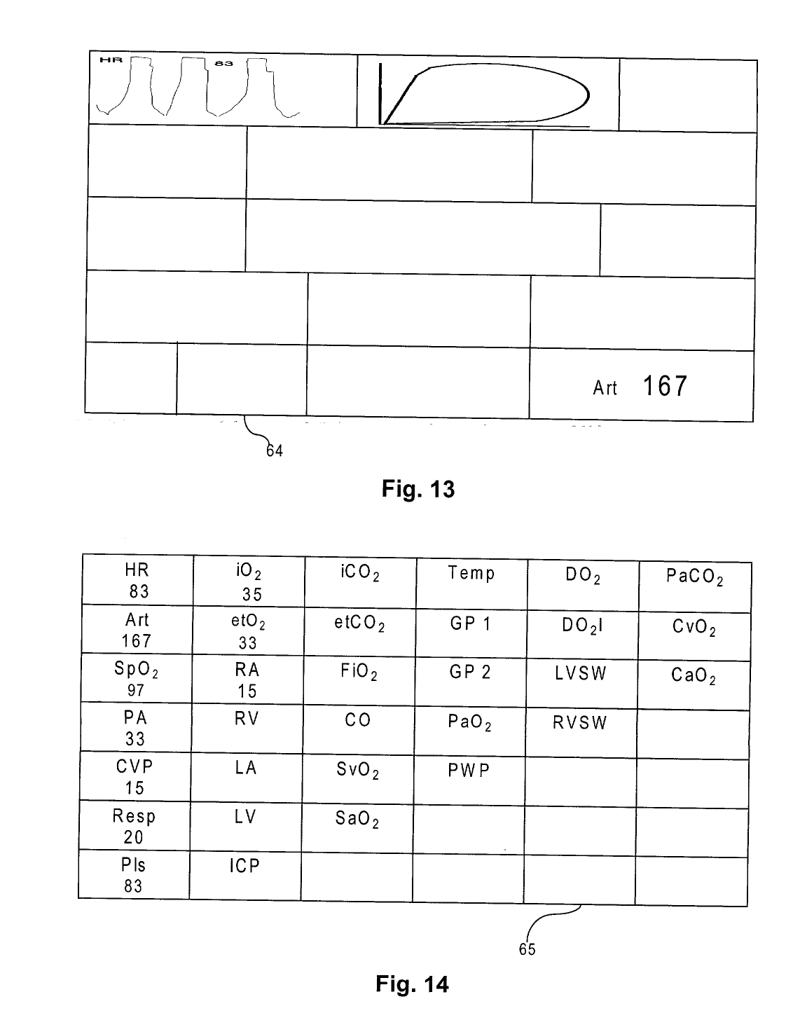

Additional cell manipulations are possible. FIG. 11 depicts the table 44 shown in FIG. 3 after cells 45 and 46 have been highlighted by use of the COLOR command shown in menu 43. FIG. 12 depicts the arrangement of data in table 63 that might be chosen by a first user who has stored this configuration via the menu 7 depicted in FIG. 19. FIG. 13 depicts the same data displayed in table 64 having different cells as selected by a second user. The second user has also changed the number and dimensions of the cells in table 64.

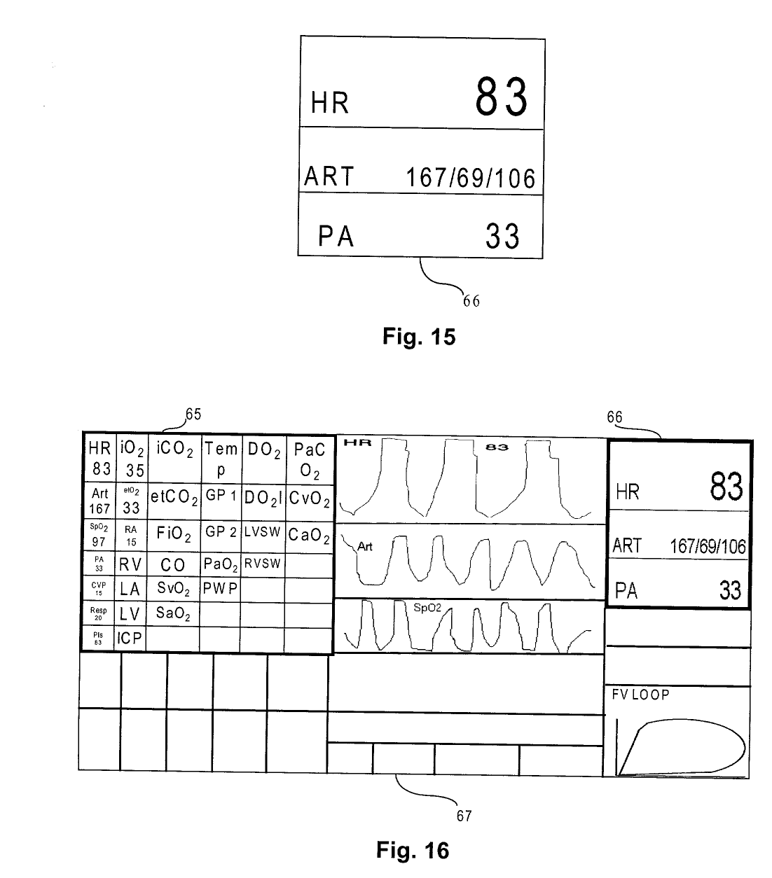

FIG. 14 depicts a seven row six column table 65 initially created by the user interface 10 shown in FIG. 1. Within some of the cells a user has placed various parameters by selecting the PARAMETER command and its associated submenus as depicted in FIG. 9. FIG. 15 depicts a three row single column table 66 containing three cells of parameter data. FIG. 16 depicts a table 67 having multiple cells. The tables 65 and 66 have been inserted into the table 67 by choosing the ADD and TABLE commands from the menus 43 and 61 of FIG. 9.

What is claimed is:

1. A method in a computer system for designing under the control of a user a display of information, comprising the steps of:
(a) receiving instructions from the user to select a tabular format;
(b) in response to step (a), displaying to the user a menu of data selections which may be placed within portions of the tabular format; and
(c) adjusting dimensions of portions of the tabular format to permit display of the data selections.

2. The method of claim 1, further including the step of receiving instructions from the user via a manual pointing device.

3. The method of claim 1, further including the steps of:
displaying to the user a data selection menu including an entry representing a first waveform for possible display within a first selected portion of the tabular format;
receiving instructions from the user to display the first waveform within the first selected portion of the tabular format;
displaying to the user a data selection menu including an entry representing a second waveform for possible display within the first selected portion of the tabular format; and
receiving instructions from the user to display the second waveform within the first selected portion of the tabular format; and
simultaneously displaying the first waveform superimposed upon the second waveform within the first selected portion of the tabular format.

4. The method of claim 1, further comprising the step of displaying to the user a color selection menu listing possible background color choices for each selected portion of the tabular format.

5. The method of claim 1, further comprising the step of displaying to the user a file name selection menu displaying a region in which all previous user selections may be saved for future use.

6. A display specification method, comprising the steps of:
(a) displaying an image set of predefined tables each having a plurality of cells;
(b) selecting one of the predefined tables;
(c) displaying the predefined table;
(d) displaying a data selection menu for each cell appearing within the predefined table;
(e) selecting one data set from the data selection menu for at least one cell; and
(f) in response to the selection of step (e), adjusting the dimensions of some cells to permit legible data display.

7. The method of claim 6, further comprising the steps of:
positioning an indicator of a manual pointing device over a border of a cell within the selected table;
selecting the border of the cell over which the indicator resides;
moving the indicator to a desired position; and selecting the desired position to define a new cell border location.

8. The method of claim 6, further comprising the steps of:
positioning an indicator of a manual pointing device over a border of a column containing at least two cells within the selected table;
selecting the border of the column over which the indicator resides;
moving the indicator to a desired position;
selecting the desired position to define to define a new column border location; and
redimensioning the cells within the column so as to abut the new column border location.

9. A computerized method of displaying medical data, comprising:
obtaining at least a first and second stream of real time medical data;
displaying a table having multiple cells;
manipulating a manual pointing device to select a first cell within the table;
inserting the first data stream into the first cell;
manipulating a manual pointing device to select a second cell within the table; and
inserting the second data stream into the second cell.

10. The method of claim 9, further comprising the step of displaying a display selection menu upon selecting a cell within the table.

11. The method of claim 10, further comprising the step of listing in association the display selection menu a choice of data and cell appearance submenus.

12. The method of claim 11, further comprising the steps of:
saving the displayed table;
creating a second table having multiple cells; and
inserting the saved table into a cell of the second table.

13. The method of claim 12, further comprising the step of inserting a display generated in response to an internet connection into a cell of the second table.
